(19) United States
(12) Patent Application Publication
(10) Pub. No.: US 2012/0166929 A1
(43) Pub. Date: Jun. 28, 2012

(54) SYSTEM AND METHOD FOR PROVIDING A CONTEXT-SENSITIVE USER INTERFACE

(75) Inventors: Roderick C. Henderson, Apex, NC (US); John R. Hind, Raleigh, NC (US); Yongchen Li, Cary, NC (US)

(73) Assignee: International Business Machines Corporation, Armonk, NY (US)

(21) Appl. No.: 12/980,113

(22) Filed: Dec. 28, 2010

(51) Int. Cl. G06F 17/24

(52) U.S. Cl. 715/224

(57) ABSTRACT

Exemplary embodiments disclose a method and system for providing a context-sensitive user interface. The method and system include dynamically creating an ontology by storing data values entered by different users from the same or different computers into fields of at least one form, where the data values stored in the ontology includes both verified data that has been verified by at least one workflow, and unverified data that has not been verified by the at least one workflow; in response to a current user interacting with a current form, retrieving from the ontology the data values made by the different users and presenting the retrieved data values to the current user as autocomplete suggestions, where the autocomplete suggestions includes the verified data and the unverified data; dynamically adjusting the autocomplete suggestions for the current user of the current form as new data values of other users are received and stored in the ontology; and distinguishing the unverified data from the verified data using at least one of a visual representation and an audio representation of the quality of the autocomplete suggestions.

### BACKGROUND

It is common today for business enterprises to offer users web or browser-based forms for data entry. In some systems, the forms can be stored in an electronic forms repository and automatically routed through predefined work flow processes. Workflow processes may include rules and business logic that validates and approves the user entries to ensure the information is as accurate as possible.

One vexing problem in today's web-based form applications is the trade-off in ease of use and quality of the entered data when a user fills-in business forms. Most approaches to data entry rely on imposing a predefined fixed ontology on new transactions and various accelerators to ease the burden of typing form input.

Three typical techniques are employed to enforce the fixed ontology scheme. First is the use of select fields where the user must choose from a list of predefined values, for example, selecting a state from the list of allowed states. The second is to run a verification procedure as one types a field or clicks an action button (e.g. only numbers allowed and/or must have name and address field filled in and/or customer not found—confirm entry). The third is to have a workflow process in place to verify transactions.

A typical acceleration technique called “autocomplete” is provided by most web browsers wherein previously entered form data is remembered and made available for selection as one types in a field. Some implementations extend this to remember relationships between fields. For example, when one fills in a user ID, the corresponding remembered password will be filled in. Many web search engines offer what is termed “autosuggest” or “incremental search” that provides the user with suggested queries or results as they type their query into a web form. There are also a number of application plug-ins, which recover form input across all form fields and allow the user to select between these historical copies.

What is needed is an improved user interface for form data entry that generates context sensitive autocomplete lists.

### BRIEF SUMMARY

Exemplary embodiments disclose a method and system for providing a context-sensitive user interface. The method and system include dynamically creating an ontology by storing data values entered by different users from the same or different computers into fields of at least one form, where the data values stored in the ontology includes both verified data that has been verified by at least one workflow, and unverified data that has not been verified by the at least one workflow; in response to a current user interacting with a current form, retrieving from the ontology the data values made by the different users and presenting the retrieved data values to the current user as autocomplete suggestions, where the autocomplete suggestions includes the verified data and the unverified data; dynamically adjusting the autocomplete suggestions for the current user of the current form as new data values of other users are received and stored in the ontology; and distinguishing the unverified data from the verified data using at least one of a visual representation and an audio representation of the quality of the autocomplete suggestions.

### BRIEF DESCRIPTION OF THE DRAWINGS

FIG. 1 is a logical block diagram illustrating an exemplary system environment in which one embodiment for providing a context-sensitive user interface system may be implemented.

FIG. 2 is a diagram illustrating a process for providing a context-sensitive user interface according to an exemplary embodiment.

FIGS. 3A-3C are diagrams showing an example illustrating a context sensitive user-interface for a client application displaying a form object.

### DETAILED DESCRIPTION

The present invention relates to methods and systems for providing a context-sensitive user-interface. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The exemplary embodiments provide methods and systems for a dynamic ontology driven context-sensitive autocomplete form that reacts to the changing data across the form's user population and visually flags field values that are out-of-context or have not been accepted into the ontology. This provides optimum user performance for high quality data entry and enables application verification work flows. In one embodiment, the dynamic ontology can be used to interact with form entry users by indicating which autocomplete entries require verification by a workflow and by requesting user verification of those entries.

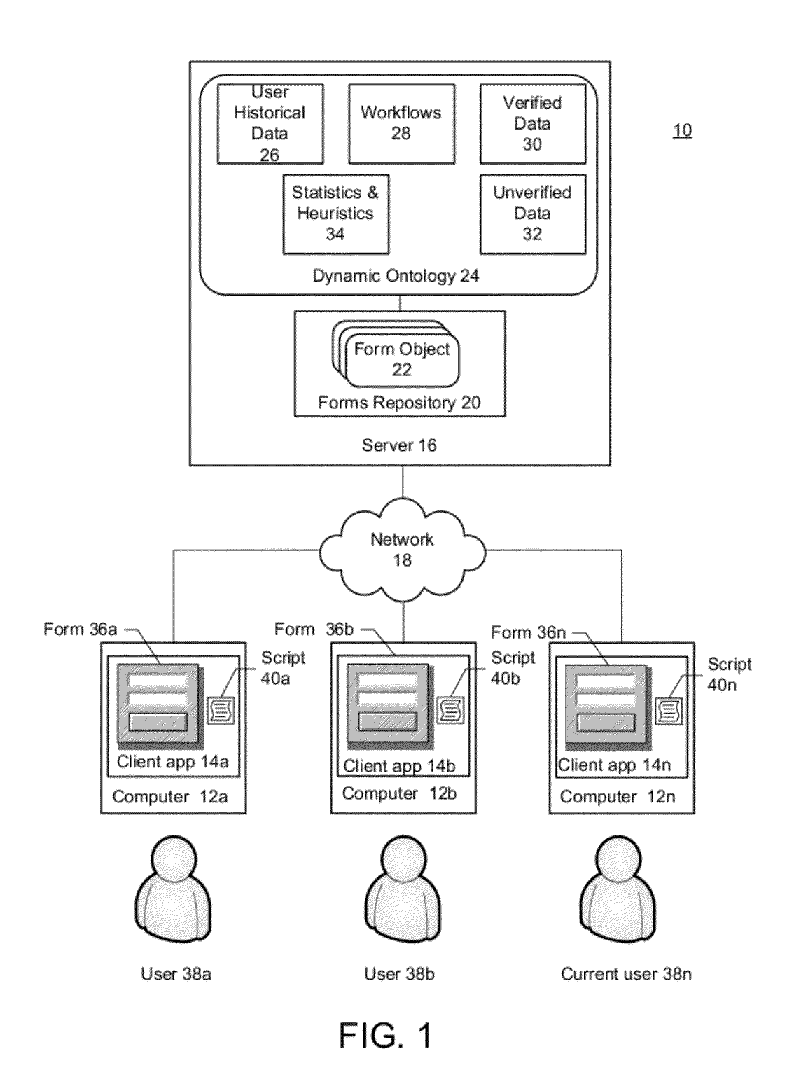

FIG. 1 is a logical block diagram illustrating an exemplary system environment for implementing one embodiment of a form entry context-sensitive user. The system 10 may include one or more computers 12a, 12b, 12n (collectively, computers 12) executing respective client applications 14a, 14b, 14n (collectively, client applications 14) that communicate with a server 16 over network 18. The network 18 may be a public network, such as the Internet, or a private network (such as an intranet), a LAN, a WLAN, or a WMAX, or a combination of thereof. In one embodiment, the server 16 may comprise a Web server, while in another embodiment, the server 16 may comprise an application server.

The computers 12 may exist in various forms, including a personal computer (PC), (e.g., desktop, laptop, or notebook), a mobile phone, a personal digital assistant (PDA), a set-top box, a game system, and the like. Both the server 16 and the computer 12 may include components of typical computing devices, including a processor, input devices (e.g., keyboard, pointing device, microphone for voice commands, buttons, touch screen, etc.), output devices (e.g., a display device). The server 16 and the computers 12 may further include computer-readable media, e.g., memory and storage devices (e.g., flash memory, hard drive, optical disk drive, magnetic disk drive, and the like) containing computer instructions that implement an embodiment of a context-sensitive user interface when executed by the processor.

In one exemplary embodiment, the server 16 may include a forms repository 20 containing at least one form object 22, and a dynamic ontology 24. In one embodiment, the dynamic ontology 24 represents a modified application ontology, which is a representation of knowledge as a set of concepts within a domain, and the relationships between those concepts.

The dynamic ontology 24 stores form data and keeps track of fields that are common to different forms. The dynamic ontology 24 may include user historical data 26, workflows 28, verified data 30, unverified data 32, and statistics and heuristics 34. The user historical data 26 may maintain historical records of different user's entries into the forms. The workflows 28 may represent business processes and/or procedures in which tasks are completed and verified. The statistics and heuristics 34 component may represent a process that identifies correlations between data values entered into the different fields of different forms 36 by different users 38 over time and tracks data patterns across related fields.

The client applications 14 executing on the computers 12 may access the server 16 over the network 18 using an address, such as a Universal Resource Locator (URL). During communications between the client applications 14 and the server 16, the client applications 14 may create and send requests to the server 16, such as Hypertext Transfer Protocol (HTTP) requests. In response, the server 16 may return the form object 22, which causes the client applications 14 to display representative forms 36a, 36b, 36n (collectively, forms 36) for user entry. One basic function of the form object 22 is to display form fields in the forms 36 and to receive values entered in those fields by different users 38a, 38b, 38n (collectively, users 38). In an enterprise environment, for example, the form object 22 may display an order form relating to product orders and the different users 38 may enter order information through a user interface of the client application 14.

In one embodiment, Asynchronous JavaScript and XML (AJAX) may be used to provide the form 36 with a dynamic ontology-driven context-sensitive user-interface auto-complete form input capability. AJAX is a web development technique for creating interactive web applications that allows web pages to be updated asynchronously by exchanging small amounts of data with the server 16. This makes it is possible to update parts of a web page, without reloading the whole page. According to one embodiment, the form object 22 is downloaded to the computers 12 with a script 40a, 40b, 40c (hereinafter, scripts 40), such as a JavaScript™.

The scripts 40 execute on the computers 12 to perform functions relating to interacting with the dynamic ontology 24, such as storing data values entered by the users 38 into the form 36, and retrieving data from the dynamic ontology 24 to generate autocomplete suggestions for the form entries. The script 40 is connected asynchronously to the server-based form object 22 that accesses the dynamic ontology 24. The form object 22 is aware of the relationship between fields in the forms 36 and past data entry values of each user 38 to present appropriate autocomplete suggestions.

In one embodiment, input to the client applications 14 is text-based and example types of client applications 14 may include a browser, an applet, a desktop application, and the like. In this embodiment, the user interface may comprise a graphical user interface (GUI) for a client application 14 such as for a browser, for example. In an alternative embodiment (not shown), rather than being text-based, the client applications 14 may comprise voice applications into which the user speaks information, rather than types information. The server 16 may be equipped with a voice response front-end that prompts the users 38 to enter form-field values by voice and enters the spoken values into the form fields.

The values entered by the different users 38, whether by text or voice, are stored within the dynamic ontology 24 under each user's historical data 26. The order of the forms 36 displayed and/or the order of the input of data into fields of the form 36 may be controlled by one or more workflows 28. The workflows 28 may also validate entered data values. Entered data values approved and validated by the workflows 28 comprises verified data 30, while data values entered into the dynamic ontology 24, but not yet approved by the workflow 28, comprises unverified data 32.

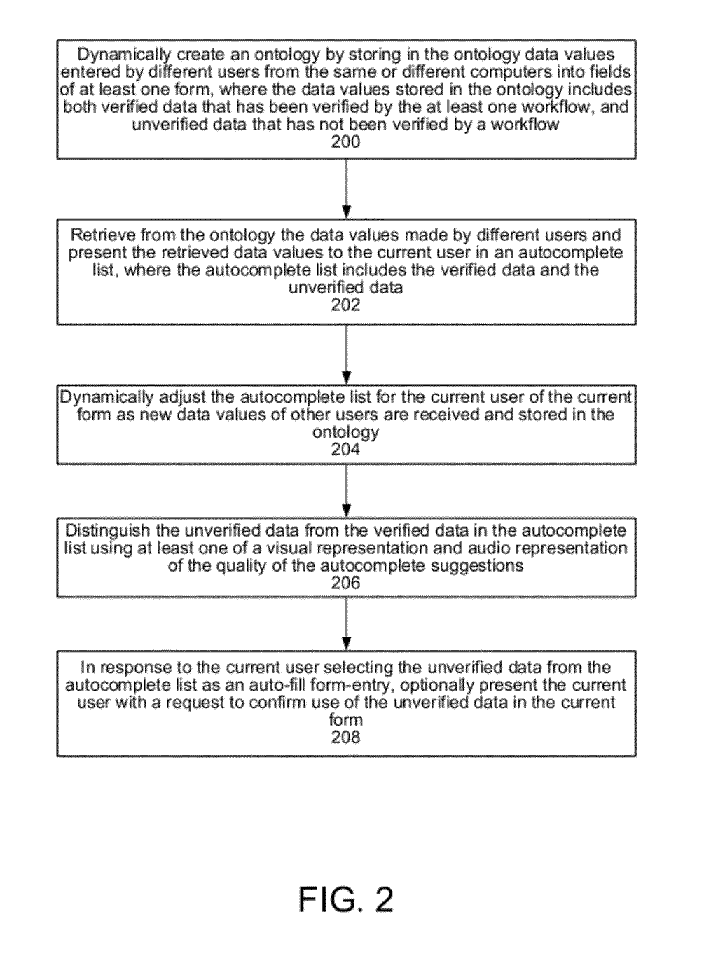

FIG. 2 is a diagram illustrating a process for providing a context-sensitive user interface according to an exemplary embodiment. According to one embodiment, the form objects 22 along with script 40 and the dynamic ontology 24 transform the user interface of the client applications 14 into a context-sensitive user-interface for improved form data entry.

The process may include dynamically creating an ontology by storing data values entered by different users 38 from the same or different computers 12 into fields of at least one form 36, the data values stored in the ontology including both verified data 30 have been verified by the at least one of the workflows 28, and unverified data 32 that has not been verified by one of the one of the workflows 28 (step 200).

In a further embodiment, the statistics and heuristics 34 component may be used to generate statistics that identify correlations between the data entered by the different users 38. The correlations may include correlations between the data entered by a particular user into a particular form or forms, and correlations between the data entered into particular fields of particular forms by some or all of the different users.

In response to a current user 30n interacting with a current form, the context-sensitive user-interface retrieves from the dynamic ontology 24 the data values made by different users 38 and presents the data values to the current user 38n as autocomplete suggestions, where entries comprising the autocomplete suggestions include the verified data 30 and the unverified data 32 (step 202). In one embodiment, as a current user 38n interacts with the web page form 36n or voice entry form, the script 40n retrieve past entry values made by different users 38 from the dynamic ontology 24 and presents a subset of the entry values to the current user 38n as autocomplete suggestions. The ontology is referred to as a dynamic ontology 24 because data entries made by the different users 38 and stored by the system may be made available to the client application 14n as autocomplete suggestions substantially in real-time.

For graphical-user-interface (GUI) based client applications 14, the autocomplete suggestions may be implemented as a list box or menu of text entries. In one embodiment, an autocomplete list is presented only for the current field into which the users entering data. However, entries for an autocomplete list for each field may be pre-fetched based on the identity of user, the current form, and previous entries input to the form by the user for example.

For non-GUI client applications 14, such as the user-interface of a voice response application, the autocomplete suggestions may comprise audio playback of recorded entries or the recorded entries played back along with an audio tone.

According to another aspect of the exemplary embodiment, the verified data 30 and the unverified data 32 stored in the dynamic ontology 24 are both made available as autocomplete suggestions. However, the verified data 30 may be in-context or out-of-context with the current user 38n and/or with fields related to a current field the current user 38n is entering. In-context verified data is verified data 30 that is determined to be currently used in the context of the current user's identity and/or in the context of fields related to the current form field. Out-of-context verified data is verified data 30 that is determined to not be currently used in the context of the current user's identity or any related fields.

In one embodiment, the statistics and heuristics 34 may be used to determine which data values form the dynamic ontology to make available as autocomplete suggestions to the current user 38n. This determination may be based on correlations between a current field selected by the user 38n and past data values entered into the same or related fields of the same or different forms 36 by the same or different users 38. Such correlations may provide context information for the data values of a particular form field. Metrics regarding the data entry values are collected as data entry values are input and the correlation is determined between values based on attributes. Statistical methods may be used to find correlations. For example, a threshold may be used to determine the correlation between the data entered into Form A and Form B by a particular group of people. In one embodiment, the statistics and heuristics 34 component may quantify the quality of data retrieved from the dynamic ontology and presented to a form. Here, quality may refer to statistical relationship between data of related fields or data entered by a particular user, where the quality is a measure of the probability of the statistical relationship. For example, if a user 38 typically processes a lot of orders for customer “A”, when the user accesses a form 36 and starts typing in the customer field, the system may determine there is a 90% chance that the user will type “A” in the customer field. For a different user, the system may determine there is a 2% chance. These probabilities may be used to generate autocomplete suggestions that are presented to the user as possible field entry values to autocomplete the field.

The context-sensitive user-interface dynamically adjusts the autocomplete suggestions for the current user 38n of the current form 36n as new data values of other users are received and stored in the ontology (step 204). As described above, these new data values of the other users may have been entered into the same or different forms 36 as the current form 36n. Thus, the autocomplete suggestions presented to a current user 38n of a current form 36n are dynamically updated based on completed field values of other users 38 in the same or different forms 36 and across different computers 12.

The user-interface may distinguish the unverified data 32 from the verified data 30 using at least one of a visual representation and an audio representation of the quality of the autocomplete suggestions (step 206). In one embodiment, the visual representation may comprise highlighting the different types of autocomplete suggestions. However any type of graphic, icon, picture or text may be used to create a visual representation or flag to the current user 38n of the quality of the autocomplete suggestions. Either the unverified data 32 or the verified data 30 may be highlighted, or both the unverified data 32 and verified data may be highlighted in different colors.

In non-GUI client applications 14, the representation of the quality of the entries in audio-based autocomplete suggestions may comprise different audio tones or tones of voice in voice response applications.

In one specific embodiment, three types of entries may be presented as autocomplete suggestions of current form field; 1) in-context verified data 30, 2) out-of-context verified data 30, and 3) the unverified data 32. In this embodiment, the in-context verified data 30 may be presented as autocomplete suggestions without highlighting, while the out-of-context verified data 30 and the unverified data 32 may be presented as autocomplete suggestions with different types of highlighting. For example, a first highlight, perhaps a yellow background, could be used to signify out-of-context verified data values in the dynamic ontology 24 that have been verified by one of the workflows 28, but have not been used in the context of any related fields or the user's identity. A second highlight, perhaps a pink background, could be used signify the unverified data values not yet accepted by one of the workflows 28. With this highlighting scheme, the user interacting with the form object 22 may be instantly apprised of the quality of the entries comprising the autocomplete list.

Determining whether or not data has been used in-context of the current user's identity may be made using the user historical data 26, and determining whether or not it has been used in the context of fields related to the current form field may be made based on the statistics and heuristics 34.

In response to the current user selecting the unverified data 32 from the autocomplete suggestions as an auto-fill form-entry, the context-sensitive user-interface may optionally present the current user 38n with a request to confirm use of the unverified data 32 as a completed entry in the field (step 208). In one embodiment, the request for verification may also be performed for out-of-context verified data entries. In one embodiment, the request for verification comprises generation of a confirmation checkbox within the GUI of the client application 14 based on the quality of selected entries. In one embodiment, a confirmed auto-fill form-entry may be displayed in the current field in a manner that retains the highlighting.

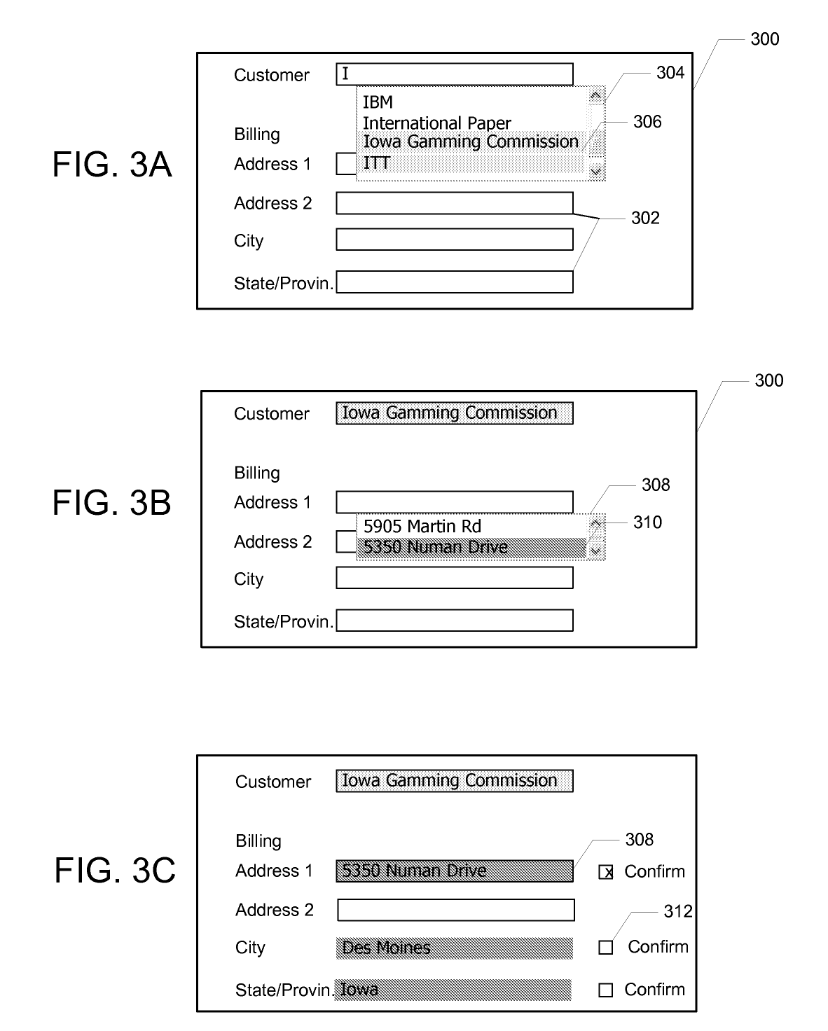

FIGS. 3A-3C are diagrams showing an example illustrating a context sensitive user-interface for a client application displaying a form object. In the example, the context sensitive user-interface displays a fragment of an order form 300 having customer name and billing address fields 302. In FIG. 3A a current user named Ralph is entering an order for the customer “Iowa Gaming Commission” for the first time and begins to type “I” into the customer name field on the form. In response, the context sensitive user-interface displays an autocomplete list 304 for the customer name field.

Users have previously entered orders for the “Iowa Gaming Commission” as well as for “ITT”, and these entries are stored in the dynamic ontology 24 as verified data 30 approved by one of the workflows 28. However, since the Ralph has not previously used either of these entries the entries are outside of Ralph's context. Therefore, the user interface displays the two out-of-context entries with a first type of highlighting 306 (e.g., yellow fill) as autocomplete suggestions 304. Ralph clicks the autocomplete entry for the “Iowa Gaming Commission” to avoid having to type the full name in the customer filed and the entry for the “Iowa Gaming Commission” is used as an autocomplete entry in the field with the highlighting. The cursor is then automatically moved to the “Address 1” field under “Billing”.

FIG. 3B shows an autocomplete list 308 for the “Address 1” field displaying two possible entries. The first entry, “5905 Martin Rd”, exists as verified data 30 in the dynamic ontology 24 within the “Iowa Gaming Commission” billing context, meaning there is a statistical relationship between the data values of the two fields (e.g., the value “5905 Martin Rd” has been previously used in the address field for the customer “Iowa Gaming Commission”). Because this entry is in-context, the entry is displayed as an autocomplete suggestion 308 without highlighting. The second entry, “5250 Numan Drive”, was entered within one of the work flows 28 of a previous transaction, but has not been verified. Therefore, the entry is stored as unverified data 32 in the dynamic ontology 24 and is displayed with the second type of highlighting 310 (e.g., pink fill).

As shown in FIG. 3C, Ralph clicks the second entry and the address field is auto populated with the second entry and the remaining form fields are automatically filled with related City and Sate/Province values from a transaction history in the work flows 28. As these related fields are also unverified data 32, they are also presented with the second type of highlighting 310. In addition, confirmation boxes 312 are presented next to each of the unverified data entries to request the user to confirm entry of these possibly low-quality picks. Ralph then verifies the values by clicking the check boxes as he proceeds.

Should Ralph attempt to submit the form without checking all the confirmation boxes 312, then the submit form action may fail, in which case focus is adjusted to the first unchecked confirmation box 312. Successfully submitting the form will move the form object 22 into an appropriate work flow queue so appropriate action can be taken, such as, for example, validating that Ralph is allowed to enter an order for this customer and that the billing address is valid so that the address can be verified and made part of the dynamic ontology 24.

Accordingly, the context-sensitive user-interface of the exemplary embodiments suggests to a current user 38n not only data entry values from the dynamic ontology 24 that have been validated, but also provides feedback for new values entered into the dynamic ontology 24 that are pending approval by one of the workflows 28. For example, in the example above, the customer has a new address and has multiple orders pending in the system. The context-sensitive user-interface enables a user to use the new address with new orders even though the new address has not yet been verified.

Although in one exemplary embodiment, the client application 14 may be describes as being a web browser, the exemplary embodiments are not limited only to web browsers. Other types of client interfaces can be used that have the ability to have active code behind the user interface (UI). One example type of environment is the Eclipse environment for a mobile device UI. The example embodiments are particularly advantageous in the mobile device UI because of limited space and any help to aid would speed the process of turnaround entries.

A system and method for providing a context-sensitive user-interface has been disclosed. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-RAN) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method for providing a context-sensitive user interface, comprising:
dynamically creating an ontology by storing data values entered by different users from the same or different computers into fields of at least one form, where the data values stored in the ontology includes both verified data that has been verified by at least one workflow, and unverified data that has not been verified by the at least one workflow;
in response to a current user interacting with a current form, retrieving from the ontology the data values made by the different users and presenting the retrieved data values to the current user as autocomplete suggestions, where the autocomplete suggestions includes the verified data and the unverified data;
dynamically adjusting the autocomplete suggestions for the current user of the current form as new data values of other users are received and stored in the ontology; and
distinguishing the unverified data from the verified data using at least one of a visual representation and an audio representation of a quality of the autocomplete suggestions.

2. The method of claim 1 further comprising, in response to the current user selecting the unverified data from the autocomplete suggestions as an auto-fill form-entry, presenting the current user with a request to confirm use of the unverified data in the current form.

3. The method of claim 2 wherein, presenting to the current user a request to confirm use of the unverified data further comprises displaying a confirmation box.

4. The method of claim 1 further comprising generating statistics that identify correlations between the data values entered by the different users and using the statistics to determine which data values form the ontology to make available as the autocomplete suggestions.

5. The method of claim 1 wherein distinguishing the unverified data from the verified data using a visual representation of the quality of the autocomplete suggestions comprises using at least one of a highlight, a graphic, an icon, a picture or text;

6. The method of claim 1 wherein distinguishing the unverified data from the verified data using an audio representation of the quality of the autocomplete suggestions comprises using an audio tone.

7. The method of claim 1 further comprising using the statistics to determine whether the verified data is in-context with the current user or with the fields related to a current field the current user is entering, or is out-of-context, and wherein the distinguishing the unverified data from the verified data as autocomplete suggestions further comprises:
presenting in-context verified data as the autocomplete suggestions without highlighting; and
presenting out-of-context verified data and the unverified data as the autocomplete suggestions with different types of highlighting.

8. The method of claim 1 wherein presenting the retrieved data values to the current user as autocomplete suggestions further comprises presenting the autocomplete suggestions to the current user in substantially real-time.

9. An executable software product stored on a computer-readable medium containing program instructions for providing a context-sensitive user interface, the program instructions for:
dynamically creating an ontology by storing data values entered by different users from the same or different computers into fields of at least one form, where the data values stored in the ontology includes both verified data that has been verified by at least one workflow, and unverified data that has not been verified by the at least one workflow;
in response to a current user interacting with a current form, retrieving from the ontology the data values made by the different users and presenting the retrieved data values to the current user as autocomplete suggestions, where the autocomplete suggestions includes the verified data and the unverified data;
dynamically adjusting the autocomplete suggestions for the current user of the current form as new data values of other users are received and stored in the ontology; and
distinguishing the unverified data from the verified data using at least one of a visual representation and an audio representation of the quality of the autocomplete suggestions.

10. The executable software product of claim 9 further comprising, in response to the current user selecting the unverified data from the autocomplete suggestions as an auto-fill form-entry, presenting the current user with a request to confirm use of the unverified data in the current form.

11. The executable software product of claim 10 wherein, presenting to the current user a request to confirm use of the unverified data further comprises displaying a confirmation box.

12. The executable software product of claim 9 further comprising generating statistics that identify correlations between the data values entered by the different users and using the statistics to determine which data values form the ontology to make available as the autocomplete suggestions.

13. The executable software product of claim 9 wherein distinguishing the unverified data from the verified data using a visual representation of the quality of the autocomplete suggestions comprises using at least one of a highlight, a graphic, an icon, a picture or text.

14. The executable software product of claim 9 wherein distinguishing the unverified data from the verified data using an audio representation of the quality of the autocomplete suggestions comprises using an audio tone.

15. The executable software product of claim 9 further comprising using the statistics to determine whether the verified data is in-context with the current user or with the fields related to a current field the current user is entering, or is out-of-context, and wherein the distinguishing the unverified data from the verified data as autocomplete suggestions further comprises:
presenting in-context verified data as the autocomplete suggestions without highlighting; and
presenting out-of-context verified data and the unverified data as the autocomplete suggestions with different types of highlighting.

16. The executable software product of claim 9 wherein presenting the retrieved data values to the current user as autocomplete suggestions further comprises presenting the autocomplete suggestions to the current user in substantially real-time.

17. A system comprising:
a server coupled to a network;
an ontology accessible by the server, the ontology storing data values entered by different users from the same or different computers into fields of at least one form, where the data values stored in the ontology includes both verified data that has been verified by at least one workflow, and unverified data that has not been verified by the at least one workflow;
a client application executing on a computer coupled to the network in communication with the server, the client application and the server in combination configured to,
in response to a current user interacting with a current form, retrieve from the ontology the data values made by the different users and present the retrieved data values to the current user as autocomplete suggestions, where the autocomplete suggestions includes the verified data and the unverified data;
dynamically adjust the autocomplete suggestions for the current user of the current form as new data values of other users are received and stored in the ontology; and
distinguish the unverified data from the verified data as autocomplete suggestions using at least one of a visual representation and an audio representation of a quality of the autocomplete suggestions.

18. A computer-implemented method for context-sensitive user interface, comprising:
dynamically creating an ontology by,
storing in the ontology data entered by different users into fields of at least one form during at least one workflow, the data stored in the ontology including both data verified by the at least one workflow, and unverified data;
generating statistics that identify correlations between the data entered by the different users, and
using the statistics to present in real-time to a current user interacting with the at least one form autocomplete suggestions based on the verified data and the unverified data;
highlighting the autocomplete suggestions that comprise the unverified data; and
in response to the current user selecting the unverified data as an auto-fill form entry, presenting to the current user a request for verification of the auto-fill form entry.
